(19) United States
(12) Patent Application Publication
(10) Pub. No.: US 2007/0031038 A1
(43) Pub. Date: Feb. 8, 2007

(54) Boolean complement methods and systems for video image processing a region of interest

(75) Inventor: Keith L. Curtner, St. Paul, MN (US)

Correspondence Address: Kris T. Fredrick;Attorney, Intellectual Prop. Honeywell Intr. Inc., 101 Columbia Rd., P.O. Box 2245, Morristown, NJ, 07962, US

(73) Assignee: Honeywell International Inc.

(21) Appl. No.: 11/197,158

(22) Filed: Aug. 3, 2005

(51) Int. Cl. G06K 9/34

(52) U.S. Cl. 382/173

(57) ABSTRACT

An image-processing method, system and program-product. Data indicative of a video image displayable with a display device associated with a data-processing apparatus can be scanned. At least one region of non-interest among the data can be identified, in response to compiling the data. Thereafter, at least one region of interest associated with the video image can be designed, such that the region of interest is equivalent to the data indicative of the video image minus the region of non-interest, thereby permitting the region of interest to be defined for focusing image-processing operations thereof upon the video image. The region of interest can comprise a geometrically regular shape or an irregular shape.

### TECHNICAL FIELD

Embodiments are generally related to video image processing methods and systems. Embodiments also relate to regions of interest (ROIs) associated with a video image. Embodiments additionally relate to techniques for specifying a region of interest (ROI) in a video image.

### BACKGROUND OF THE INVENTION

Detecting a region of interest in images is a common feature of many image processing software applications. Conventional digital image recognition software routines, for example, are capable of detecting an ROI. Generally, an image is composed of many objects that can be defined by pixels. A group of pixels is referred to as a region. A target is an object of interest. A prototype contains information about a type of target. An image-processing component may therefore detect a region in an image that matches the prototype.

Algorithmic video image processing software applications typically require the specification of an ROI to define a limiting context in which to focus image-processing computations. The ROI may be, for example, a full video frame, or more typically, a subset of the full video image. Specifying an ROI that is smaller than the full image results in less computation and hence, less “real estate” data, to handle, which in turn can save processing time and enhance efficiency.

To date, specification of an ROI has been accomplished for relatively simple geometric areas of a full frame video source. More complex video analytic tasks are now being undertaken in the domain that will require specifying more complex ROI's. A need thus exists for a methodology and system, which results in the specification of ROI's in a more user-friendly and efficient manner for certain ROI configurations. It is believed that the method, system and program product disclosed herein address this emerging need.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for improved image-processing methods and systems, including a program product thereof.

It is another aspect of the present invention to provide for a technique for specifying a region of interest of a video image for image-processing thereof.

The aforementioned aspects and other objectives and advantages can now be achieved as described herein. An image-processing method, system and program-product are disclosed. Data indicative of a video image displayable with a display device associated with a data-processing apparatus can be scanned. At least one region of non-interest among the data can be identified, in response to compiling the data. Thereafter, at least one region of interest associated with the video image can be designed, such that the region of interest is equivalent to the data indicative of the video image minus the region of non-interest, thereby permitting the region of interest to be defined for focusing image-processing operations thereof upon the video image. The region of interest can comprise a geometrically regular shape or an irregular shape.

The method, system and program product disclosed herein addresses the fact that certain video image processing applications may contain scenes that contain known physical region(s) within which there is a high probability of significant activities that are essentially noise in the context of the surveillance, security or access functions of the video image processing algorithms. In many cases, it is therefore more efficient to be able to describe the region of interest in terms of the full image minus (Boolean ‘NOT’) the regions of non-interest. Such a technique therefore obviates the construction of a complex ROI and can simplify the user interface requirements for specifying the ROI.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a block diagram of a representative data-processing apparatus in which a preferred embodiment can be implemented;

FIG. 2 illustrates a block diagram of a full video frame and a region of interest thereof;

FIG. 3 illustrates a block diagram of a full video frame and a region of non-interest in accordance with a preferred embodiment;

FIG. 4 illustrates a high-level flow chart of operations depicting logical operational steps that can be implemented in accordance with a preferred embodiment;

FIG. 5 illustrates an example of a complex Boolean complement region of interest of a sample video image, in accordance with an embodiment;

FIG. 6 illustrates the sample video image depicted in FIG. 5, in accordance with an embodiment;

FIG. 7 illustrates an excluded region of interest of the sample video image depicted in FIG. 5, in accordance with an embodiment;

FIG. 8 illustrates the outline of a particular area of the excluded region of interest indicated in FIG. 5, in accordance with an embodiment;

FIG. 9 depicts particular areas of the excluded region of interest indicated in FIG. 5, in accordance with an embodiment;

FIG. 10 illustrates an excluded region of interest minus the particular areas depicted in FIG. 9, in accordance with an embodiment;

FIG. 11 illustrates a complement region of interest and a region of interest in accordance with an embodiment;

FIG. 12 illustrates a region of interest in accordance with an embodiment; and

FIG. 13 illustrates an identified region of interest in accordance with an embodiment.

### DETAILED DESCRIPTION

The particular values and configurations discussed in these non-limiting examples can be varied and are cited merely to illustrate at least one embodiment and are not intended to limit the scope thereof.

Note that the embodiments disclosed herein can be implemented in the context of a host operating system and one or more software modules. Such modules may constitute hardware modules, such as, for example, electronic components of a computer system. Such modules may also constitute software modules. In the computer programming arts, a software module can be typically implemented as a collection of routines and data structures that performs particular tasks or implements a particular abstract data type.

Software modules generally comprise instruction media storable within a memory location of a data-processing apparatus and are typically composed of two parts. First, a software module may list the constants, data types, variable, routines and the like that can be accessed by other modules or routines. Second, a software module can be configured as an implementation, which can be private (i.e., accessible perhaps only to the module), and that contains the source code that actually implements the routines or subroutines upon which the module is based. The term module, as utilized herein can therefore refer to software modules or implementations thereof. Such modules can be utilized separately or together to form a program product that can be implemented through signal-bearing media, including transmission media and recordable media.

It is important to note that, although the present invention is described in the context of a fully functional data-processing apparatus (e.g., a computer system), those skilled in the art will appreciate that the mechanisms of the present invention are capable of being distributed as a program product in a variety of forms, and that the present invention applies equally regardless of the particular type of signal-bearing media utilized to actually carry out the distribution. Examples of signal bearing media include, but are not limited to, recordable-type media such as floppy disks or CD ROMs and transmission-type media such as analogue or digital communications links.

The embodiments disclosed herein may be executed in a variety of systems, including a variety of computers running under a number of different operating systems. The computer may be, for example, a personal computer, a network computer, a mid-range computer or a mainframe computer. In the preferred embodiment, the computer is utilized as a control point of network processor services architecture within a local-area network (LAN) or a wide-area network (WAN).

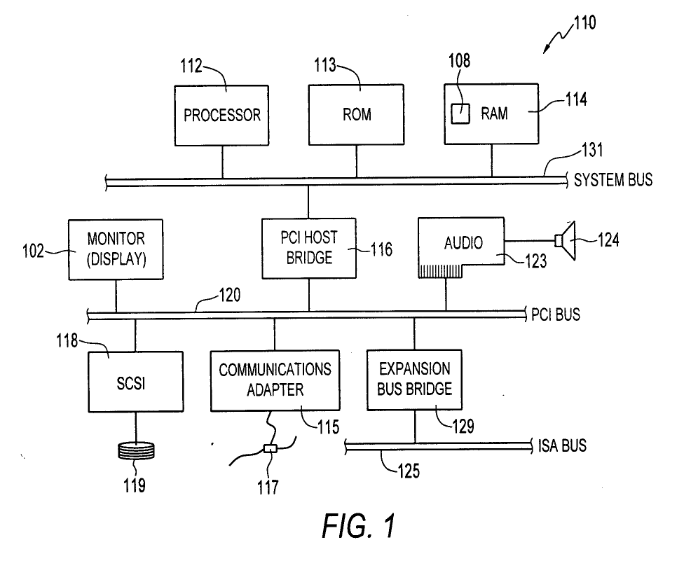

Referring now to the drawings and in particular to FIG. 1, there is depicted a block diagram of a representative data-processing apparatus 110 (e.g., computer) in which a preferred embodiment can be implemented. As shown, processor (CPU) 112, Read-Only memory (ROM) 113, and Random-Access Memory (RAM) 114 are connected to system bus 131 of data-processing apparatus 110. CPU 112, ROM 113, and RAM 114 are also coupled to Peripheral Component Interconnect (PCI) local bus 120 of data-processing apparatus 110 through PCI host-bridge 116. PCI Host Bridge 116 provides a low latency path through which processor 112 may directly access PCI devices mapped anywhere within bus memory and/or input/output (I/O) address spaces. PCI Host Bridge 116 also provides a high bandwidth path for allowing PCI devices to directly access RAM 114.

Also attached to PCI local bus 120 are communications adapter 115, small computer system interface (SCSI) 118, and expansion bus-bridge 129. Communications adapter 115 is utilized for connecting data-processing apparatus 110 to a network 117. SCSI 118 is utilized to control high-speed SCSI disk drive 119. Expansion bus-bridge 129, such as a PCI-to-ISA bus bridge, may be utilized for coupling ISA bus 125 to PCI local bus 120. In addition, audio adapter 123 is attached to PCI local bus 120 for controlling audio output through speaker 124. Note that PCI local bus 120 can further be connected to a monitory 102, which functions as a display (e.g., a video monitor) for displaying data and information for a user and for interactively displaying a graphical user interface (GUI). In alternate embodiments, additional peripheral components may be added or existing components can be connected to the system bus. For example, the monitor 102 and the audio component 123 along with speaker 124 can instead be connected to system bus 131, depending upon design configurations.

Data-processing apparatus 110 also preferably includes an interface such as a graphical user interface (GUI) and an operating system (OS) that reside within machine readable media to direct the operation of data-processing apparatus 110. In the preferred embodiment, OS (and GUI) contains additional functional components, which permit network-processing components to be independent of the OS and/or platform. Any suitable machine-readable media may retain the GUI and OS, such as RAM 114, ROM 113, SCSI disk drive 119, and other disk and/or tape drive (e.g., magnetic diskette, magnetic tape, CD-ROM, optical disk, or other suitable storage media). Any suitable GUI and OS may direct CPU 112.

Further, data-processing apparatus 110 preferably includes at least one network processor services architecture software utility (i.e., program product) that resides within machine-readable media, for example a custom defined service utility 108 within RAM 114. The software utility contains instructions (or code) that when executed on CPU 112 interacts with the OS. Utility 108 can be, for example, a program product as described herein.

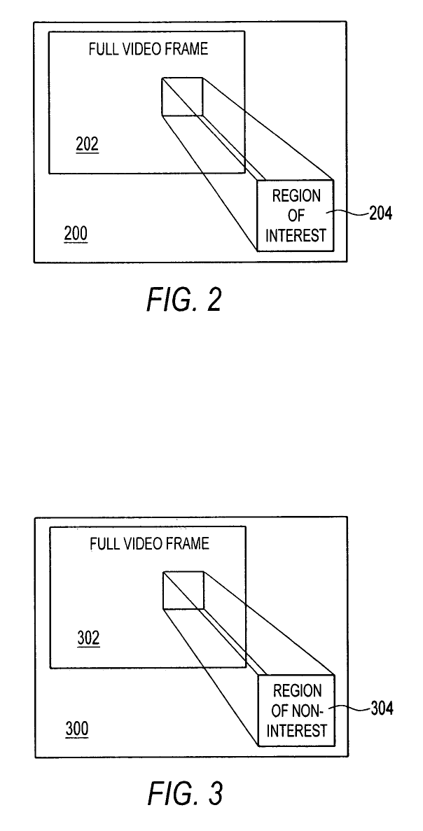

FIG. 2 illustrates a block diagram of an image-processing system 202 including a full video frame 202 and a region of interest (ROI) 204 thereof. As indicated previously, algorithmic video image processing software applications require the specification of an ROI 204 to define a limiting context in which to focus image-processing computations. The ROI 204 may be, for example, a full video frame; such as video frame 202 depicted in FIG. 2, or more typically, a subset of the full video image 202. Specifying an ROI that is smaller than the full image results in less computation. Note that video image 202 can be displayed via a display unit, such as monitor 102 depicted in FIG. 1.

The traditional definition of the ROI 204 is a closed polygon, circle or other close region within the full video image 202. One example application of such an ROI 204 involves the description of an ROI that includes images of background scene physical features (e.g., doorways, walkways, windows, high-value articles such as paintings, cash registers, etc.). In such cases a simple rectangular ROI 204 is sufficient.

FIG. 3 illustrates a block diagram of an image-processing system 300 including a full video frame 302 and a region of non-interest (RONI) 304 in accordance with a preferred embodiment. In general, there exist certain applications in which one might wish, for reasons of ease of description, to describe the ROI as the full video image 302 but with the exclusion of a region of non-interest (RONI). As indicated in FIG. 3, the region of interest is not limited to geometrically regular shapes, but can include any closed shape. A video frame such as video frame 302 depicted in FIG. 3 may have multiple regions of non-interest. Note video frame or image 302 can be displayed via a display device such as monitor 102 depicted in FIG. 1.

Certain video image-processing applications may contain scenes that contain known physical region(s) within which there is a high-probability of significant activities that are essentially “noise” in the context of surveillance, security or access functions of the video image-processing methodology or system. In many cases, it is easier to be able to describe the ROI in terms of the full image 302 (i.e., Boolean “NOT”), the regions of non-interest. Such a methodology obviates the construction of a complex ROI and simplifies user interface requirements for specifying the ROI. Note that as utilized herein the term “Boolean” generally refers to the system of logic/algebraic processes developed by George Boole, during the 19th century. The most well-known examples of Boolean are the AND, OR and NOT operators. Computers, for example, use logic gates within their processors to carry out the Boolean instructions.

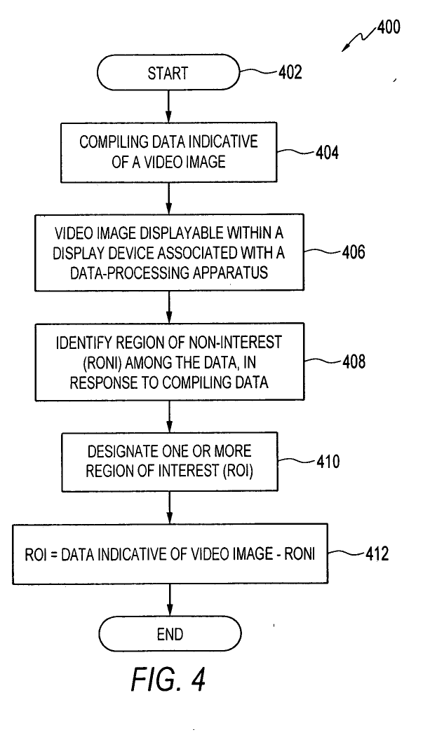

FIG. 4 illustrates a high-level flow chart 400 of operations depicting logical operational steps that can be implemented in accordance with a preferred embodiment. Note that in FIGS. 1 and 3-4, identical or similar parts or elements are generally indicated by identical reference numerals. The methodology depicted in FIG. 4 can be implemented as a software module (s) and/or program product as described earlier. The logical operations depicted in FIG. 4 can be stored as a software module (e.g., utility 108 depicted in FIG. 1) and processed via a processor (e.g., see processor 112 of FIG. 1).

As indicated by block 402, the process is initiated and thereafter, as depicted at block 404, data indicative of a video image 302 can be compiled. As indicated next at block 406, the video image 302 can be displayed utilizing a display device associated with data-processing apparatus 100. Next, as depicted at block 408, one or more regions of non-interests (RONI's) can be identified among the data, in response to compiling the data. A single RONI 304 can thus be identified or a number of RONI's depending upon design considerations. Thereafter, as depicted at block 410, one or more ROIs associated with the video image 302 can be designated. As indicated at block 412 each ROI is equivalent to the data indicative of the video image 302 minus the RONI, thereby permitting the ROI to be defined for focusing image-processing operations thereof upon the video image 302.

By utilizing the methodology described herein, it can be appreciated that a number of benefits can accrue. For example, smaller ROI's are possible with the Boolean complement methodology described herein, thereby requiring fewer computations. Boolean complement definitions are also easier to describe, thus reducing associated operator set-up efforts.

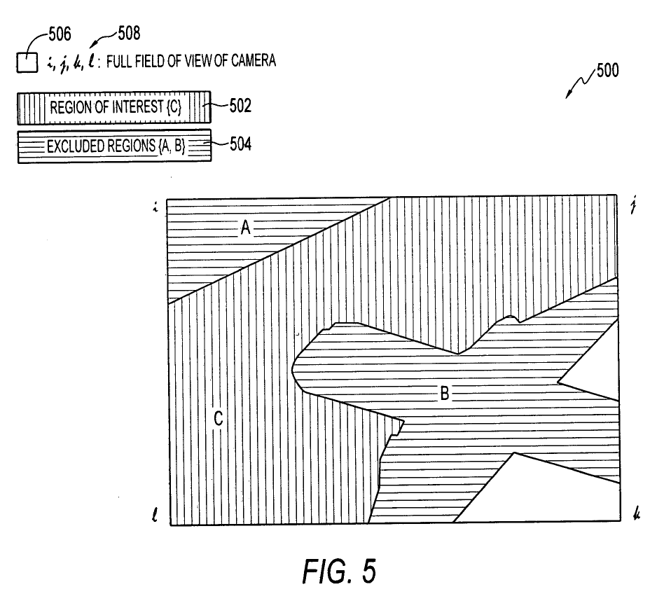

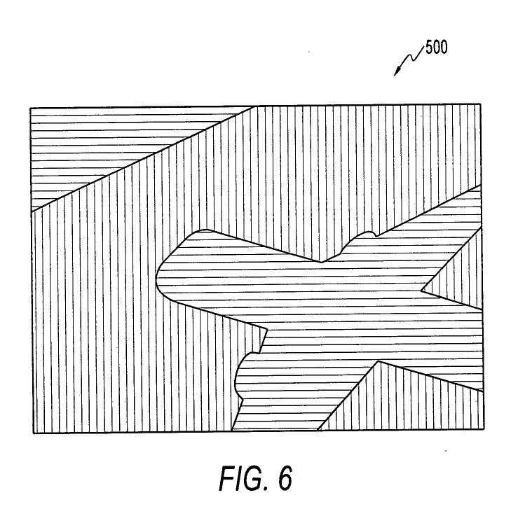

FIG. 5 illustrates an example of a complex Boolean complement region of interest of a sample video image 500, in accordance with an embodiment. As indicated in FIG. 5, a region of interest 502 is associated with region C, while excluded regions of interests 504 are associated with regions A and B. A legend 506 indicates a full field view of camera associated with letters i, j, k, and l. Note that FIG. 6 illustrates a full view of the sample video image depicted in FIG. 5, in accordance with an embodiment;

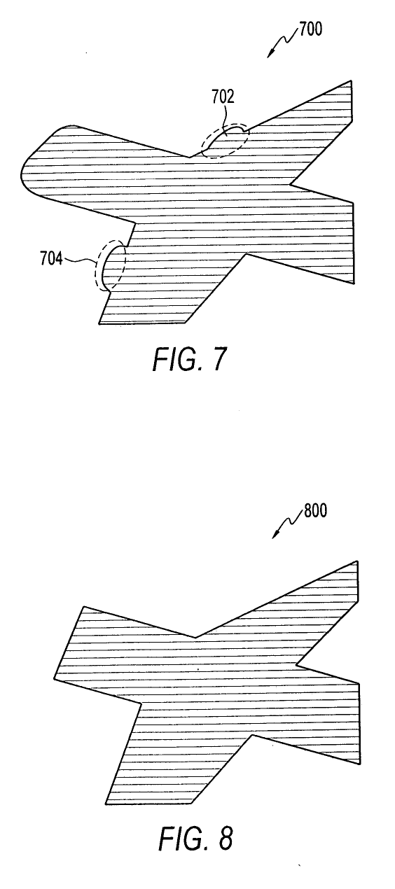

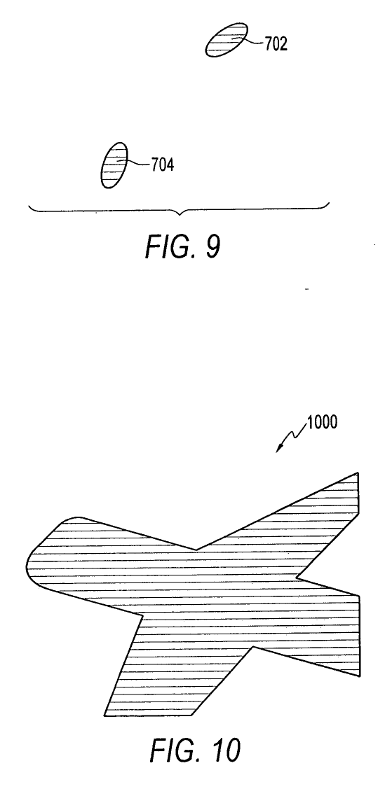

FIG. 7 illustrates an excluded region of interest 700 of the sample video image depicted in FIG. 5, in accordance with an embodiment. The excluded ROI 700 is essentially equivalent to region B depicted in FIG. 5. In FIG. 7, regions or areas 702, 704 are specifically identified. FIG. 8 illustrates the outline of a particular area of the excluded region of interest indicated in FIG. 5, in accordance with an embodiment. FIG. 9 depicts particular areas 702, 704 of the excluded region of interest B indicated in FIG. 5 and as depicted in FIG. 7 in accordance with an embodiment.

FIG. 10 illustrates an excluded region of interest 1000 minus the particular areas 702, 704 depicted in FIG. 9, in accordance with an embodiment. Note that the ROI 1000 depicted in FIG. 10 is therefore analogous to the region B depicted in FIG. 5 but without areas 702, 704 as depicted in FIG. 9 and FIG. 7.

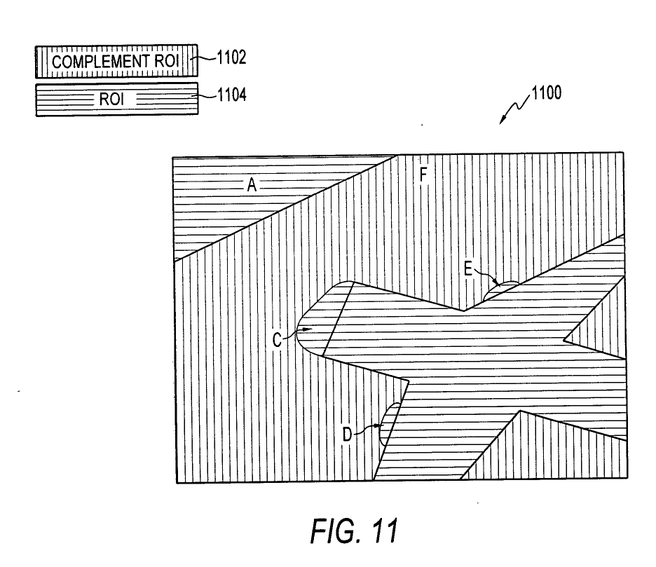

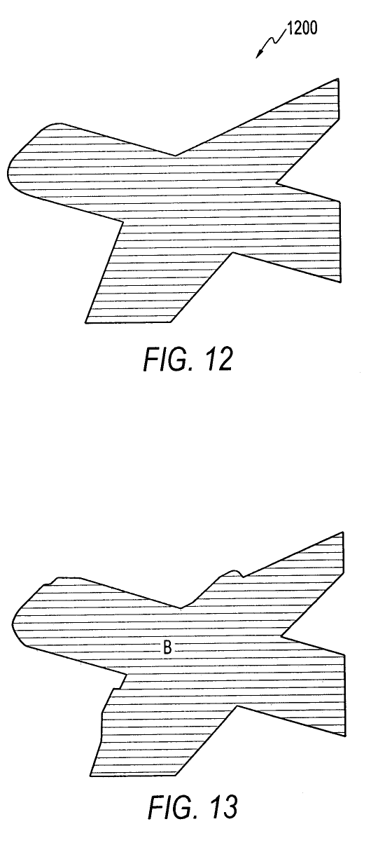

FIG. 11 illustrates a complement region of interest 1102 and a region of interest 1104 in accordance with an embodiment. A sample video image 1102 is depicted in FIG. 7, with identified ROI's A, C, D, and E and a complement ROI F. Note that regions D and E are analogous to regions 702, 704 described earlier. FIG. 12 illustrates a region of interest 1200 in accordance with an embodiment. FIG. 13 illustrates an identified region of interest 1300 in accordance with an embodiment, which associated with region B.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. An image-processing method, comprising:
compiling data indicative of a video image displayable with a display device associated with a data-processing apparatus;
identifying at least one region of non-interest among said data, in response to compiling said data; and
thereafter designating at least one region of interest associated with said video image, wherein said at least one region of interest is equivalent to said data indicative of said video image minus said at least one region of non-interest, thereby permitting said at least one region of interest to be defined for focusing image processing operations thereof upon said video image.

2. The method of claim 1 wherein said at least one region of interest comprises a geometrically regular shape.

3. The method of claim 1 wherein said at least one region of interest comprises an irregular shape.

4. The method of claim 1 wherein said at least one region of interest comprises a closed shape.

5. The method of claim 1 wherein said at least one region of interest comprises a pixel.

6. The method of claim 1 wherein said at least one region of interest comprises a plurality of pixels displayable with said display device associated with said data-processing apparatus.

7. The method of claim 1 wherein said at least one region of non-interest comprises a known physical region of said video image having a high-probability of noise.

8. An image-processing system, comprising:
a data-processing apparatus associated with a display device, wherein data indicative of a video image is displayed;
a module for identifying at least one region of non-interest among said data and thereafter designating at least one region of interest associated with said video image, wherein said at least one region of interest is equivalent to said data indicative of said video image minus said at least one region of non-interest, thereby permitting said at least one region of interest to be defined for focusing image processing operations thereof upon said video image.

9. The system of claim 8 wherein said at least one region of interest comprises a geometrically regular shape.

10. The system of claim 8 wherein said at least one region of interest comprises an irregular shape.

11. The system of claim 8 wherein said at least one region of interest comprises a closed shape.

12. The system of claim 8 wherein said at least one region of interest comprises a pixel.

13. The system of claim 8 wherein said at least one region of interest comprises a plurality of pixels displayable with said display device associated with said data-processing apparatus.

14. The system of claim 8 wherein said at least one region of non-interest comprises a known physical region of said video image having a high-probability of noise.

15. The system of claim 8 wherein said data-processing apparatus further comprises a computer.

16. The system of claim 8 wherein said data-processing apparatus further comprises a processor for processing said module.

17. A program-product for image-processing; comprising:
data indicative of a video image displayable with a display device associated with a data-processing apparatus;
instruction media residing in a memory of said data-processing apparatus for identifying at least one region of non-interest among said data and thereafter designating at least one region of interest associated with said video image, wherein said at least one region of interest is equivalent to said data indicative of said video image minus said at least one region of non-interest, thereby permitting said at least one region of interest to be defined for focusing image processing operations thereof upon said video image.

18. The program product of claim 17 wherein said instruction media are retrievable from said memory of said data-processing apparatus, in response to a particular user input to said data-processing apparatus.

19. The program product of claim 17 wherein said at least one region of interest comprises a geometrically regular shape.

20. The program product of claim 17 wherein said at least one region of interest comprises an irregular shape.
